(19) United States
(12) Patent Application Publication
(10) Pub. No.: US 2011/0039063 A1
(43) Pub. Date: Feb. 17, 2011

(54) APERTURED NONWOVEN FABRIC AND PROCESS AND APPARATUS FOR PRODUCING SAME

(76) Inventors: Samuel Charles Baer, Greenville, SC (US); Jay Darrell Gillespie, Mt. Juliet, TN (US); David D. Newkirk, Greer, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/445,655

(22) PCT Filed: Oct. 10, 2007
(86) PCT No.: PCT/US07/80901

§ 371 Date: Sep. 29, 2010

Related U.S. Application Data
(60) Provisional application No. 60/829,778, filed on Oct. 17, 2006.

(51) Int. Cl. D04H 13/00; B32B 3/10; D04H 1/00; B28B 1/48; B29C 59/04

(52) U.S. Cl. 428/132; 428/131; 264/156; 425/294

(57) ABSTRACT

Disclosed is a process for continuous perforation of fabrics that comprise thermoplastic fibers. The process utilizes a combination of heat and pressure to perforate fabrics where the shape. size, and distribution of the individual fabric perforations is define solely by the design of the pattern embossing roll, In particular, the top side of the individual embossing points are not flat but rather have a raised peripheral edge so that the actual fabric contact area of the bond points is much less than total area circumscribed by each bond point. The small ratio of fabric contact area to total bond area concentrates the thermal and compressive forces in the embossing nip and allows a large perforation to be cut out of a fabric moving at high speed through the perforation nip.

### FIELD AND BACKGROUND OF THE INVENTION

This invention relates to apertured nonwoven fabrics and to a method and apparatus for producing such fabrics.

It is desired to produce a fabric that has a total open area greater than about 10% of the fabric's surface at a line speed that is typical of commercial nonwoven textile production lines. This will allow production of a perforated fabric on the fabric manufacturing line and thus not require a costly separate manufacturing step. If the fabric is comprised of thermoplastic fibers then the aperturing can be accomplished continuously through a combination of heat and pressure applied at selected points on the fabric.

Several processes to produce large apertures in thermoplastic fabrics are described in the patent literature. Shimalla in U.S. Pat. No. 4,588,630 describes a two-step process where a high pressure thermal embossing calender melts small holes into a thermoplastic fabric and the fabric is then subjected to non-recoverable stretch in the MD and/or CD directions to enlarge the holes. The melted edges of eth perforation may contribute to the strength and integrity of the apertured fabric.

Benson in U.S. Pat. No. 5,916,661 describes an alternate two-step process where a point bonded fabric is subjected to a second thermal emboss step where selected points on the fabric are weakened via melting but are not actually perforated. The selectively weakened fabric in then subjected to an incremental stretching process than causes the weakened points to first rupture into narrow holes and them expend to form large open apertures in the fabric.

Both the Shimalla and Benson patents have a key common feature of requiring a high degree of non-recoverable stretching of the thermally perforated or thermally weakened fabric to significantly enlarge the initial small apertures or weakened regions of the pre-stretched fabric.

Coslett et al. in U.S. Pat. Nos. 5,656,119; 5,567,501 and 5,830,555 describe thermoplastic fabric and fabric/film laminates that are optimum for forming apertures where each perforation roll emboss point has a contact area with the fabric that is essentially the same dimension as the resulting aperture. The patents teach that a blend of higher melting fiber with either lower melting temperature fibers or film favor clean, well-defined apertures. Low elongation, high tenacity polypropylene staple fibers were preferred over higher elongation lower tenacity polypropylene fibers and were superior in forming well defined apertures. Gillespie et al. in U.S. Pat. No. 6,632,504 also identifies fabric fiber compositions that yield fabrics that are especially amenable to thermal aperturing via thermal embossing followed by significant stretching.

There is a need for a process that allows fabric perforation at commercial nonwoven line production speeds while yielding a perforation pattern that is a precise replication of the desired fabric design. The Shimalla and Benson processes require extensive fabric distortion via MD and/or CD stretching to achieve larger apertures. The Coslett et al. process can yield large apertures but the thermal and compressive energies that perforate the fabric are distributed over the full area of the resulting perforation which can severely limit the maximum line speed that clean apertures can occur.

### SUMMARY OF THE INVENTION

In one aspect, the present invention provides a nonwoven fabric comprised of thermoplastic fibers bonded to one another at a multiplicity of bond sites to form a coherent, strong nonwoven web, and a plurality of apertures formed in the nonwoven fabric by removal of selected portions of the nonwoven web, the apertures forming an open area of at least 10 percent of the fabric surface area. A chad formed from the removed portion of nonwoven web may be found releasably attached to at least some of the apertures, and a margin of fused thermoplastic fiber extends along the periphery of the chad. A margin of fused thermoplastic fiber may also extend along the periphery of the apertures. The nonwoven fabric may be of various constructions, including carded thermal bond nonwoven fabrics, airlaid nonwoven fabrics and spunbond nonwoven fabric comprised of continuous filaments of thermoplastic polymer. The apertures are clean-cut and well defined and the fabric has not been subjected to non-recoverable stretching.

The present invention also provides a method of making an apertured nonwoven fabric comprising steps of: directing a nonwoven fabric comprised of thermoplastic fibers along a predetermined path of travel into and through an embossing station; contacting the nonwoven fabric at the embossing station with an embossing roll having a predetermined patterned surface; applying heat and pressure to the nonwoven fabric with the patterned surface to thermally fuse the thermoplastic fibers along a plurality of enclosed paths defining selected areas of the surface of the fabric in which apertures are to be formed; and removing the selected areas of the fabric from the remainder of the fabric. The plurality of enclosed paths of thermally fused fibers may form embossed areas that constitute no more than 10 percent of the fabric surface area and surround areas of the nonwoven fabric in which the thermoplastic fibers are unfused and unembossed. In certain embodiments, the plurality of enclosed paths of thermally fused fibers have a surface area between 2% and 20% of the area circumscribed by the enclosed paths.

The present invention also relates to an embossing roll for producing an apertured nonwoven fabric. The roll comprises a cylindrical body and a plurality of raised embossments at predetermined spaced locations over the cylindrical surface of the body, with the raised embossments including a raised land surface for contacting the fabric extending along a closed path along the periphery of the raised embossment, and a recessed surface surrounded by the raised land surface, and wherein the raised land surface has a surface area between 2% and 20% of the area surrounded by the raised land surface. In certain advantageous embodiments, the embossments are present on the roll at a density such that the raised land surface and the surrounded recessed surface constitute at least 10 percent of the surface area of the cylindrical surface.

### BRIEF DESCRIPTION OF THE DRAWINGS

Having thus described the invention in general terms, further aspects of the invention will become apparent from the detailed description which follows, and from the accompanying drawings, in which:

FIG. 1 illustrates one embodiment of a bond pattern design for an embossing roll;

FIG. 2 is a top view of the roll;

FIG. 3a is a schematic illustration of a thermal perforation process;

FIG. 3b is a schematic illustration of an ultrasonic perforation process;

FIG. 4 is a magnified photograph showing a perforated fabric showing apertures with and without chad removal; and

FIG. 5 is a magnified view of a single aperture showing the chad loosely held by the residual fibils along the circumference of the emboss region.

### DETAILED DESCRIPTION

The invention disclosed herein features a 1) emboss pattern design where the individual bond points are concave in design so that only the outer peripheral edge of each bond point is in contact with the fabric to be apertured in the nip and 2) a post embossing step is employed to clear the fabric apertures of the residual fabric that was inside of the emboss line of each bond point without any non-recoverable stretching of the fabric.

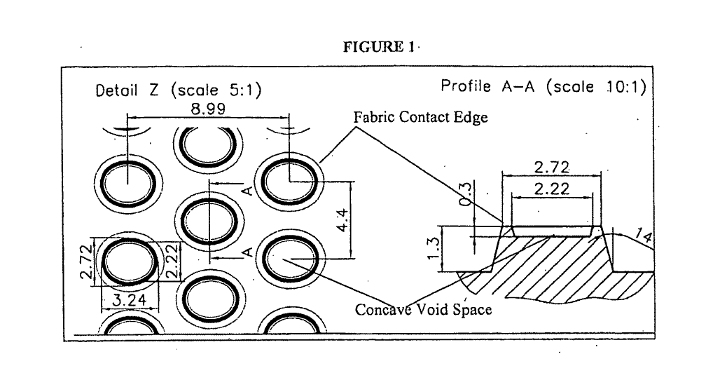

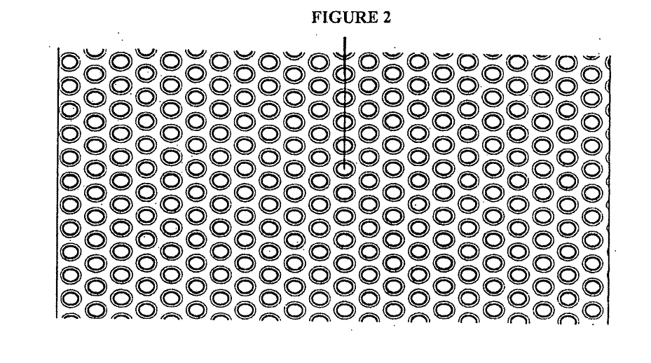

FIG. 1 shows one embodiment of such a bond pattern design (A) with a raised annular peripheral edge (B) around a central recess or void area (C). FIG. 2 shows the arrangement of the bond points (A) on a patterned embossing calender roll (D). In this embodiment the cumulative surface area occupied by the oval bond points is about 35% of the surface area of the embossing roll and the cumulative surface area of the raised annular edges on each bond point is about 5% of the surface area of the embossing roll. Thus the perforation energy in the nip is concentrated on only about 5% of the surface area of the fabric passing through the nip. This invention is not limited to any particular bond point shape or array of bond points on the embossing roll. In general, a suitable bond point design would have the fabric contact area of the bond point be between 2% and 20% of the area circumscribed by the total bond point. The size, shape, and number of bond points per unit area would vary according to the requirement of the particular application. The inventors anticipate that this method of continuous fabric perforation would have greatest utility where the desired open area of the fabric is greater than 10% of the fabric surface.

The localized heating at the fabric contact points can be either driven by thermal conduction from a heated calender roll or by high-frequency vibration of an ultrasonic horn.

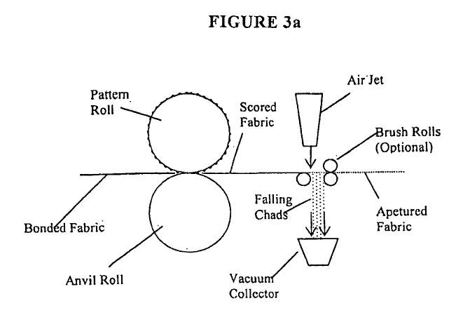

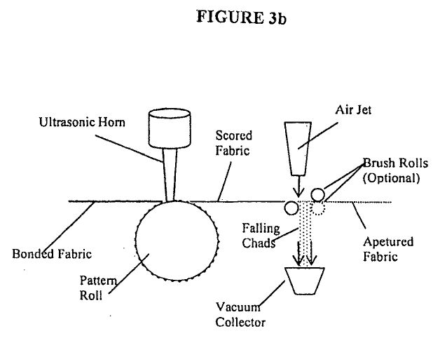

The bond point shown in FIG. 1 is designed to melt away the fabric at the contact point leaving a chad of fabric that drops out of the aperture. We found the surprising result that under proper raw material selection and embossing nip settings the chad would be very loosely held in the aperture as the embossed, scored fabric exited the nip. This allows for an easy removal of the chads from their respective apertures by a simple air jet (FIGS. 3a and 3b) as the fabric moved away from the nip. The chad removal action of the air jet may be assisted or substituted by a set of brush rolls applied to the surface of the embossed, scored fabric.

The observed fabric behavior is preferred over complete chad punch-out in the nip because the chads do not clog up the recessed void spaces of the embossing roll and the chad removal station could be removed from the vicinity of the nip to allow for ease of collection of the chads for potential recycle. It is important to note that non-recoverable stretch of the sort described in Shimalla and Benson was not at all required to remove the nonwoven fabric chads.

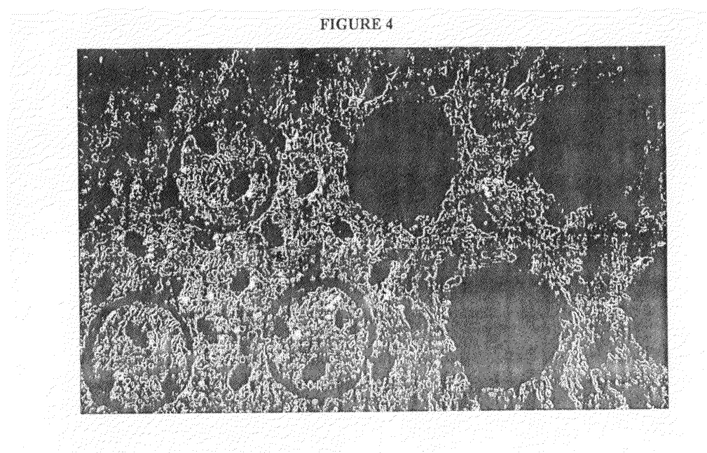

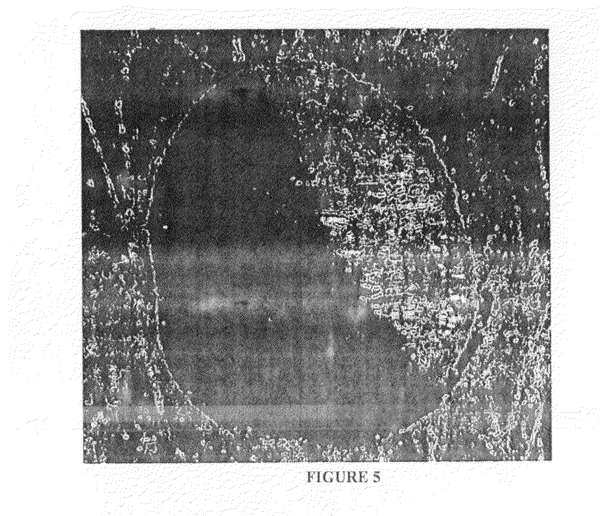

FIG. 4 shows a magnified post-emboss fabric where some of the chads have been removed and some of the chads remain in place. FIG. 5 shows a close-up view of a chad that is being partially held in place by some of the unsevered fibers of the nonwoven fabric. The fabrics shown in FIGS. 4 and 5 were embossed with the pattern described in FIGS. 1 and 2.

The advantages of this fabric aperturing process over the prior art are several. Large (e.g. 10% or greater) open areas can be created in a suitable fabric at high speed without non-recoverable fabric stretching in any direction. Non-recoverable stretching of the fabric can degrade material properties. The shape and distribution of the individual apertures can be precisely defined and will not be unpredictably distorted by subsequent web stretching. Thus, the apertures can define various patterns in the nonwoven fabric. The energy to achieve the aperture is concentrated only where it is required to cut out the large aperture. This allows for successful web aperturing at the maximum possible line speed.

### Example 1

An embossing roll with raised embossments forming a land area of about 5% of the area of the embossing roll was thermally emboss a 18 gram per square meter spunbond polypropylene spunbond nonwoven fabric at a line speed of 305 meters per minute.

### Example 2

An embossing roll as illustrated in FIGS. 1 and 2 was designed to produce an open area of at least 20% of the fabric area, but with the an annular raised land surface that would have a fabric contact area of no more than 5%.

This embossing roll was used in a calender stand against a plain surfaced anvil roll. The nip pressure was set to 1250 psi, The patterned roll was heated to 254° C. and the anvil roll at 256° C. Operating at a line speed of 100 feet/minute, this calender was employed to thermally emboss a 28.1 gram per square meter spunbond nonwoven fabric formed from continuous filaments of a sheath-core bicomponent structure with a 50% polyethylene sheath and 50% polypropylene core. When a stream of high velocity air was directed against the fabric, the chads were easily blown out of the fabric, leaving clean well-defined apertures without any tearing or distortion of the fabric. The apertured fabric was still soft.

### Example 3

The embossing procedure of Example 2 was performed on a nonwoven spunbond fabric in which the filaments had a segmented pie cross-sectional configuration consisting of six segments of alternating polypropylene and polyethylene. Apertures similar to those of Example 2 were observed.

### Example 4

An 18 gram per square meter spunbond polypropylene nonwoven fabric was thermally embossed using a embossing procedure similar to Example 2 except that the roll temperatures were increased.

### Example 5

The embossing procedure of Example 2 was carried out on a 24.1 gram per square meter spunbond-meltblown-spunbond composite nonwoven fabric laminate. The chads were readily removed by air and/or abrasion. Clean, well-defined apertures were observed and the fabric remained soft.

1. A nonwoven fabric comprised of thermoplastic fibers bonded to one another at a multiplicity of bond sites to form a coherent, strong nonwoven web, and a plurality of apertures formed in the nonwoven fabric by removal of selected portions of the nonwoven web, the apertures forming an open area of at least 10 percent of the fabric surface area.

2. The fabric of claim 1, including a chad formed from the removed portion of nonwoven web releasably attached to at least some of the apertures.

3. The fabric of claim 2 including a margin of fused thermoplastic fiber extending along the periphery of the chad.

4. The fabric of claim 1 including a margin of fused thermoplastic fiber extending along the periphery of the apertures.

5. The fabric of claim 1, wherein the nonwoven fabric is selected from the group consisting of a carded thermal bond nonwoven fabric comprising thermoplastic staple fibers, an airlaid nonwoven web comprising thermoplastic staple fibers, and a spunbond nonwoven fabric comprised of continuous filaments of thermoplastic polymer.

6. The fabric of claim 1 in which the fabric is unstretched.

7. A spunbond nonwoven fabric comprised of continuous thermoplastic filaments randomly arranged and bonded to one another at a multiplicity of bond sites to form a coherent, strong spunbond nonwoven web, and a plurality of apertures formed in the nonwoven fabric by removal of selected portions of the nonwoven web, the apertures forming an open area of at least 10 percent of the fabric surface area.

8. A method of making an apertured nonwoven fabric comprising:
directing a nonwoven fabric comprised of thermoplastic fibers along a predetermined path of travel into and through an embossing station;
contacting the nonwoven fabric at the embossing station with an embossing roll having a predetermined patterned surface;
applying heat and pressure to the nonwoven fabric with the patterned surface to thermally fuse the thermoplastic fibers along a plurality of enclosed paths defining selected areas of the surface of the fabric in which apertures are to be formed; and
removing said selected areas of the fabric from the remainder of the fabric.

9. The method of claim 8 wherein the selected areas constitute at least 10 percent of the fabric surface area.

10. The method of claim 8 wherein the plurality of enclosed paths of thermally fused fibers form embossed areas that constitute no more than 10 percent of the fabric surface area and surround areas of the nonwoven fabric in which the thermoplastic fibers are unfused and unembossed.

11. The method of claim 10 wherein the plurality of enclosed paths of thermally fused fibers have a surface area between 2% and 20% of the area circumscribed by the enclosed paths.

12. The method of claim 8 wherein the step of removing said selected areas comprises directing air onto the fabric to remove said selected areas.

13. The method of claim 1 wherein the step of removing said selected areas comprises contacting the fabric with brushes to remove said selected areas.

14. The method of claim 8 wherein the step of applying heat and pressure comprises contacting the embossing roll with a heated anvil roll or with an ultrasonic anvil.

15. An embossing roll for producing an apertured nonwoven fabric comprising a cylindrical body and a plurality of raised embossments at predetermined spaced locations over the cylindrical surface of the body, said raised embossments including a raised land surface for contacting the fabric extending along a closed path along the periphery of the raised embossment, and a recessed surface surrounded by the raised land surface, and wherein the raised land surface has a surface area between 2% and 20% of the area surrounded by the raised land surface.

16. The roll of claim 15, wherein the embossments are present on the roll at a density such that the raised land surface and the surrounded recessed surface constitute at least 10 percent of the surface area of the cylindrical surface.

17. The roll of claim 15 wherein the raised land surface constitutes from 2 to 10 percent of the surface area of the area surrounded by the raised land surface

18. The roll of claim 15 wherein the raised land surface has a width of from 10 to 30 percent of the maximum width of the raised embossment.

19. The roll of claim 15 wherein the raised embossments have a circular or oval configuration.
